(19) United States
(12) Patent Application Publication
(10) Pub. No.: US 2014/0237143 A1
(43) Pub. Date: Aug. 21, 2014

(54) Debugging Fixture

(71) Applicant: SKYMEDI CORPORATION, Hsinchu City (TW)

(72) Inventors: Bo-Wen Hsiao, Hsinchu City (TW); Ding-Yun Chen, Hsinchu City (TW)

(73) Assignee: SKYMEDI CORPORATION, Hsinchu City (TW)

(21) Appl. No.: 13/772,366

(22) Filed: Feb. 21, 2013

(51) Int. Cl. G06F 9/44

(52) U.S. Cl. CPC G06F 9/4413
USPC 710/14

(57) ABSTRACT

A fixture, for connecting a host device and a universal serial bus (USB) device, the fixture comprises a plurality of connectors; a plurality of first signal pins, located at first ends of the plurality of connectors for connecting to the host device; and a plurality of second signal pins, located at second ends of the plurality of connectors for connecting to the USB device; wherein a first part of the plurality of connectors are used for transmitting signals between the host device and the USB device in a USB mode; wherein a second part of the plurality of connectors are retained in a specified state for providing a control signal to control the USB device to enter an operating mode.

### BACKGROUND OF THE INVENTION

1. Field of the Invention

The present invention relates to a fixture, and more particularly, to a fixture for controlling a universal serial bus device to perform formatting or debugging operation.

2. Description of the Prior Art

With the improvement of technology, manufacturers are devoted to develop new products to enhance market competitiveness. Therefore, manufacturers make efforts to enhance product development and debugging speed to increase market visibility of the new products.

In general, the manufacturers execute complicated tests to confirm if the products operate in normal. When problems occur, the manufacturers have to remove or even destroy shells of the products to perform debugging operations. Therefore, extra time is required to package the products again after the problems are solved. Since the products are complicated and the appearances of the products are exquisite, how to speed up performing debugging operations and avoid from destroying the products becomes a goal of the industry.

### SUMMARY OF THE INVENTION

The present invention therefore provides a fixture for controlling a universal serial bus device to perform formatting or debugging operations.

A fixture, for connecting a host device and a universal serial bus (USB) device, is disclosed. The fixture comprises a plurality of connectors; a plurality of first signal pins, located at first ends of the plurality of connectors for connecting to the host device; and a plurality of second signal pins, located at second ends of the plurality of connectors for connecting to the USB device; wherein a first part of the plurality of connectors are used for transmitting signals between the host device and the USB device in a USB mode; wherein a second part of the plurality of connectors are retained in a specified state for providing a control signal to control the USB device to enter an operating mode.

A USB device is disclosed. The USB device comprises a USB connector, utilized for connecting to a host device; a controller, connected with the USB connector, for controlling operations of the USB device according to a control signal; a storage unit, connected with the controller, for storing data; and a fixture, connected with the USB connector, for providing the control signal.

A method for controlling operations of a universal serial bus (USB) device is disclosed. The method comprises a fixture generating a control signal according to a specified state; the USB device detecting the control signal; and the USB device entering an operating mode according to the control signal; wherein the fixture is connected between a host device and the USB device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a fixture according to the present invention.

FIGS. 2-3 are schematic diagrams of operations of the fixture in FIG. 1 according to the present invention.

FIG. 4 is a schematic diagram of a fixture according to the present invention.

FIG. 5 is a schematic diagram of a USB device according to the present invention.

FIG. 6 is a schematic diagram of a flowchart according to the present invention.

FIG. 7 is a schematic diagram of a flowchart according to the present invention.

### DETAILED DESCRIPTION

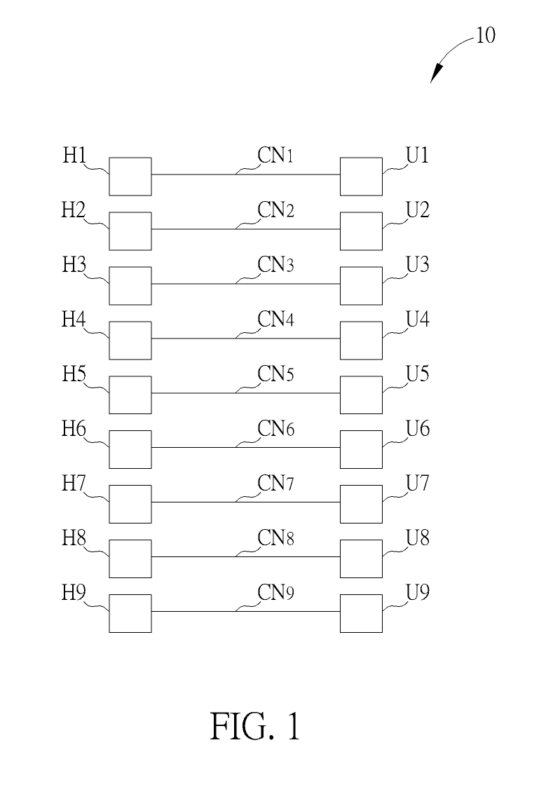

Please refer to FIG. 1, which is a schematic diagram of a fixture 10 according to an embodiment of the present invention. The fixture 10 is used for controlling a universal serial bus (USB) device to perform normal, formatting or debugging operations. As shown in FIG. 1, the fixture 10 includes connectors CN1-CN9, signal pins H1-H9 and U1-U9. The signal pins H1-H9 are located at ends of the connectors CN1-CN9 correspondingly and used for connecting to a host device. The signal pins U1-U9 are located at the other ends of the connectors CN1-CN9 correspondingly and used for connecting to the USB device. Therefore, the signal pins H1-H9 and U1-U9 can transmit signals between the host device and the USB device.

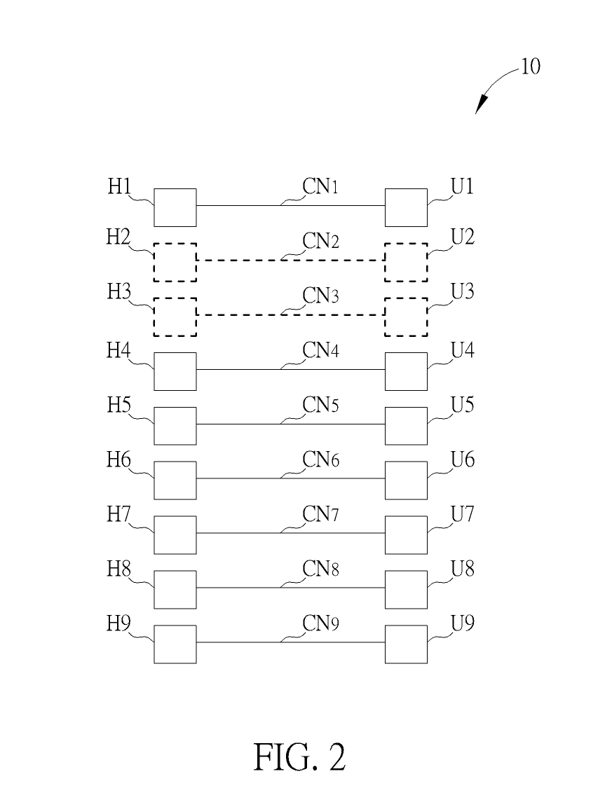

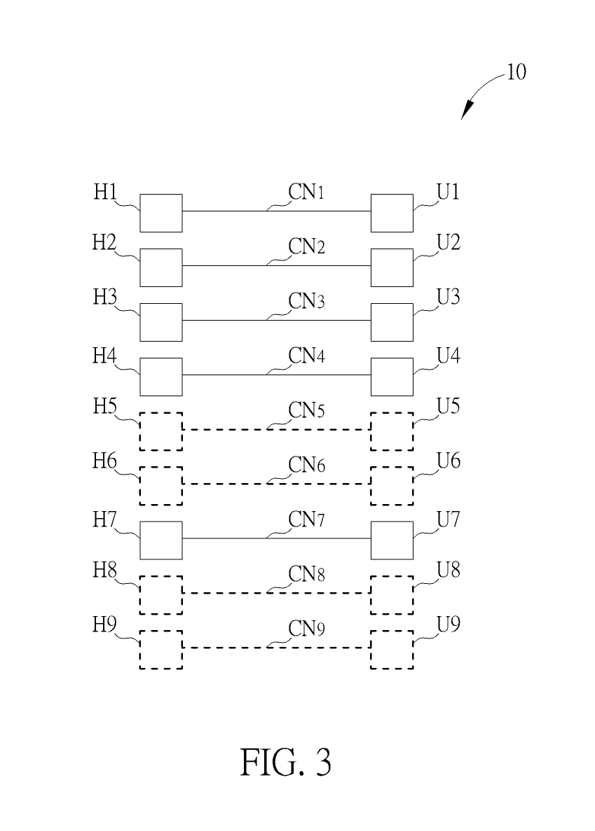

Please refer to FIGS. 2-3, which are schematic diagrams of operations of the fixture 10. As shown in FIG. 2, the fixture 10 operates in USB3.0 mode. In detail, the signal pins H5-H6 and U5-U6 are respectively and correspondingly connected with pins used as SuperSpeed receiver differential pair in the host device and the USB device, and the signal pins H8-H9 and U8-U9 are respectively and correspondingly connected with pins used as SuperSpeed transmitter differential pair in the host device and the USB device. Besides, the signal pins H1 and U1 are used for powering and the signals H4, H7, U4 and U7 are used for grounding. Since the signal pins H2-H3 and U2-U3 are unused between the host device and the USB device, the signal pins H2-H3 and U2-U3 can be retained in a specified state for providing a control signal. Therefore, the USB device can perform operations according to the control signal. In other words, when the specified state is a first pre-defined state, the USB device can stay in a normal mode, in which the fixture 10 bypasses signals between the host device and the USB device as normal operations. When the specified state is a second pre-defined state, the USB device can switch to a return materials authorization (RMA) mode, in which the USB device performs the debugging operations. When the specified state is a third pre-defined state, the USB device can switch to a low level format (LLF) mode, in which the fixture can control the USB device to perform the formatting operations.

In addition, the fixture 10 may also operate in USB2.0 mode, as shown in FIG. 3. In detail, the signal pins H1 and U1 are also used for powering and the signals H4, H7, U4 and U7 are also used for grounding. However, different to the fixture 10 in USB3.0 mode, the signal pins H2-H3 and U2-U3 are respectively and correspondingly connected with pins used as USB2.0 differential pair and used for transmitting signals between the host device and the USB device instead. Therefore, the signal pins H5-H6, H8-H9, U5-U6 and U8-U9 are unused between the host device and the USB device and can be retained in a specified state to control the operations of the USB device as described above.

In brief, when a part of the signal pins H1-H9 and U1-U9 is used for powering, grounding and transmitting signals between the host device and the USB device, the rest of the signal pins can be retained in a specified state to control the USB device to perform the normal, the formatting or the debugging operations, so that manufacturers may not require extra pins and need not to remove or destroy the shell of the USB device when performing the debugging operations. Therefore, no extra time is required to package the USB device again after the debugging operations are finished, so as to further speed up performing the debugging operations and avoid from destroying the USB device.

Note that, the fixture 10 is an example of the present invention, and those skilled in the art should readily make combinations, modifications and/or alterations on the abovementioned description and examples. For example, the specified state can be fixed or switchable between several pre-defined states. In the fixed situation, the USB device should perform the debugging operations when the fixture 10 is connected between the host device and the USB device. In the switchable situation, the specified state can be set different by using switches or bottoms. Take switches for example, if a first switch is turned off, the fixture 10 and the USB device stay in the normal mode; otherwise, the fixture 10 controls the USB device to switch to the LLF mode or the RMA mode. In a situation that the first switch is turned on, if a second switch is turned on, the fixture 10 controls the USB device to switch to the LLF mode and perform the formatting operations; otherwise, the fixture 10 controls the USB device to switch to the RMA mode and perform the debugging operations.

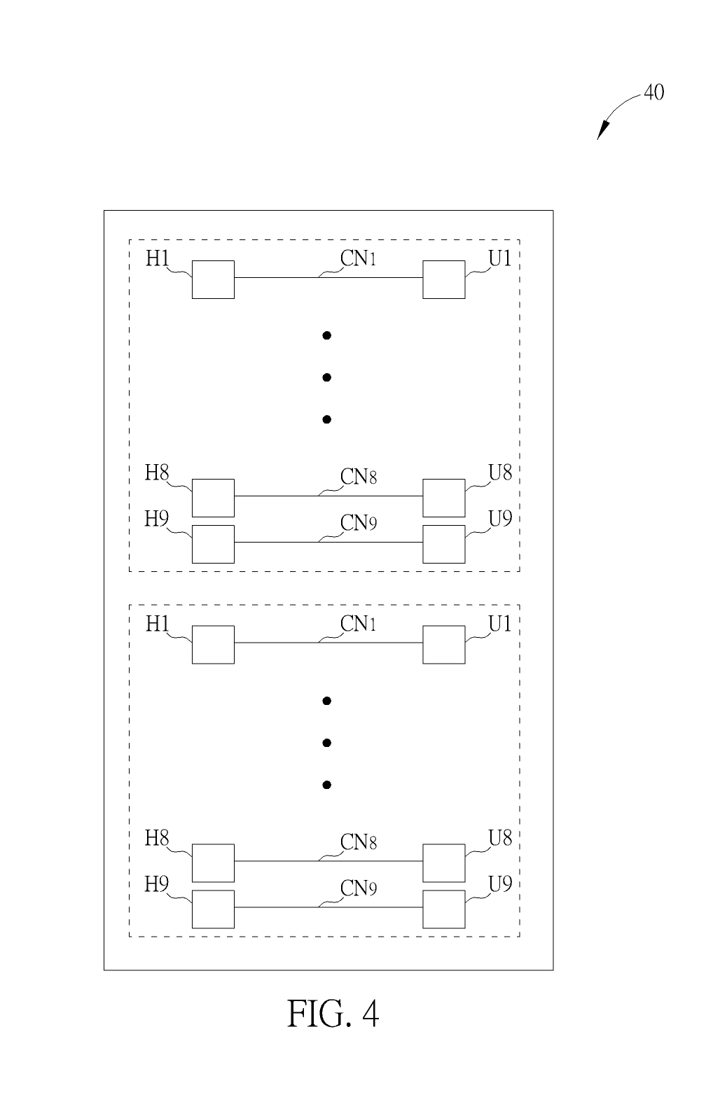

Besides, the fixture 10 may be extended and constructed by a plurality of fixtures as shown in FIGS. 1-3, so that the fixture 10 can support a plurality of USB devices at the same time. Please refer to FIG. 4, which is a schematic diagram of a fixture 40 according to an embodiment of the present invention. The fixture 40 is multiplexed by two fixtures as shown in FIGS. 1-3. In other words, the fixture 40 includes 36 signal pins and 18 connectors. The first 18 signal pins and the first 9 connectors are used for a first USB device, and the rest signal pins and connectors are used for a second USB device. Therefore, manufacturers can test the first and second USB devices at the same time.

Note that, the fixture 40 is an example of the present invention, and those skilled in the art should readily make combinations, modifications and/or alterations on the abovementioned description and examples. For example, the fixture 40 may be multiplexed by n fixtures and n can be any positive number. Besides, the fixture 40 may connect to the host device by using a hub device. Therefore, the fixture 40 may also be combined with the hub device, so that manufacturers can use the hub device to perform the debugging operations without connecting to an extra debugging device.

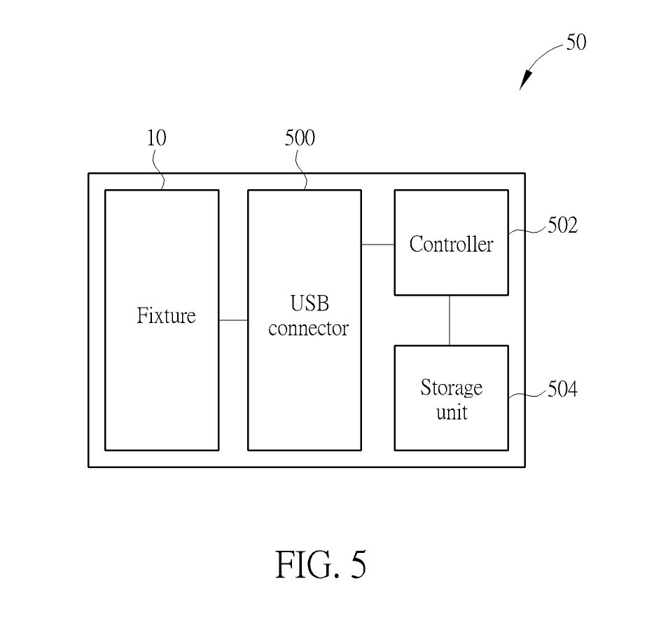

On the other hand, the fixture 10 may also be included in the USB device. Please refer to FIG. 5, which is a schematic diagram of a USB device 50 according to an embodiment of the present invention. The USB device 50 includes a USB connector 500, a controller 502, a storage unit 504 and the fixture 10. The USB connector 500 is used for connecting to the host device, and the fixture 10 is connected with the USB connector 500 for providing a control signal. The controller 502 is connected with the USB connector 500 for controlling operations of the USB device 50 according to the control signal. The storage unit 504 is connected with the controller 502 for storing data. In detail, the USB connector 500 detects the control signal generated by the fixture 10 and informs the controller 502 to switch the operating mode between the normal mode, the RMA mode and the LLF mode. In other words, the USB device 50 possesses the ability to perform the debugging operations without using other devices. Note that, the detail description of the fixture 10 is described above and no more explanation herein.

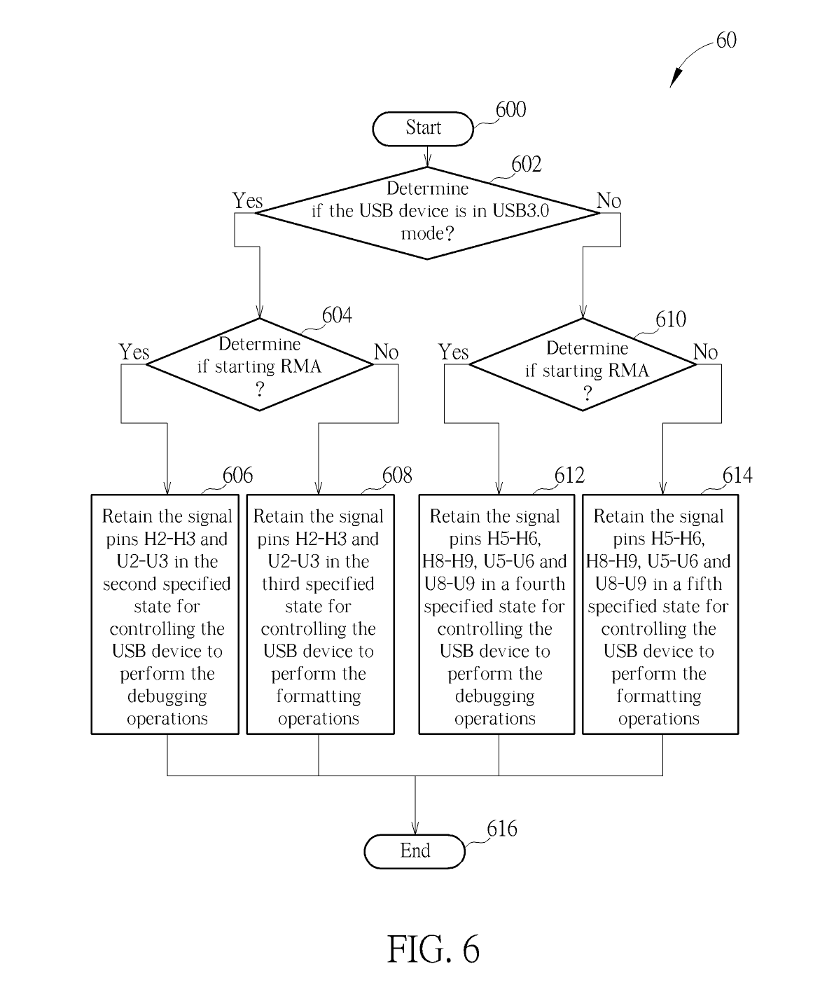

Please refer to FIG. 6, which is a schematic diagram of a flowchart 60 according to the present invention. The flowchart 60 is used in the fixture 10, for controlling the USB device to perform the formatting operations or the debugging operations. The flowchart 60 includes the following steps:

Step 600: Start.

Step 602: Determine if the USB device is in USB3.0 mode? If yes, execute step 604; if not, execute step 610.

Step 604: Determine if starting RMA? If yes, execute step 606; if not, execute step 608.

Step 606: Retain the signal pins H2-H3 and U2-U3 in the second specified state for controlling the USB device to perform the debugging operations and go to step 616.

Step 608: Retain the signal pins H2-H3 and U2-U3 in the third specified state for controlling the USB device to perform the formatting operations and go to step 616.

Step 610: Determine if starting RMA? If yes, execute step 612; if not, execute step 614.

Step 612: Retain the signal pins H5-H6, H8-H9, U5-U6 and U8-U9 in a fourth specified state for controlling the USB device to perform the debugging operations and go to step 616.

Step 614: Retain the signal pins H5-H6, H8-H9, U5-U6 and U8-U9 in a fifth specified state for controlling the USB device to perform the formatting operations and go to step 616.

Step 616: End.

In the process 60, the fixture 10 retains the unused signal pins in a specified state to provide the control signal to control the operations of the USB device. The detail description is explained as above and no more description herein.

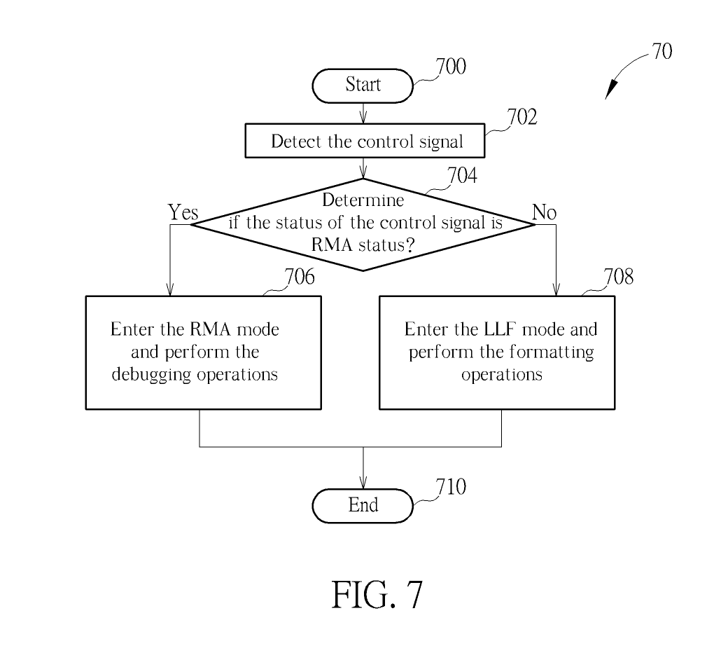

Please refer to FIG. 7, which is a schematic diagram of a flowchart 70 according to the present invention. The flowchart 70 is used in the USB device, for switching between the RMA mode and the LLF mode. The flowchart 70 includes the following steps:

Step 700: Start.

Step 702: Detect the control signal.

Step 704: Determine if the status of the control signal is RMA status? If yes, execute step 706; if not, execute step 708.

Step 706: Enter the RMA mode, perform the debugging operations and go to step 710.

Step 708: Enter the LLF mode and perform the formatting operations.

Step 710: End.

In the process 70, the USB device detects the control signal and determines the status of the control signal. Therefore, the USB device can perform the formatting operations in the LLF mode or the debugging operations in the RMA mode according to the status of the control signal. The detail description is explained as above and no more description herein.

In the present application, when a part of the signal pins of the fixture is used for powering, grounding, and transmitting signals between the host device and the USB device, the rest of the signal pins can be retained in a specified state to control the USB device to perform the formatting or the debugging operations, so that manufacturers may not require extra pins and need not to remove or destroy the shell of the USB device when performing debugging operations. Therefore, the speed of performing the formatting or the debugging operations is efficiently increased and the USB device keeps completeness.

To sum up, the present invention provides a fixture for controlling a USB device to perform debugging operations without removing or destroying the shell of the USB device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fixture, for connecting to a host device and a universal serial bus (USB) device, the fixture comprising:
a plurality of connectors;
a plurality of first signal pins, located at first ends of the plurality of connectors for connecting to the host device; and
a plurality of second signal pins, located at second ends of the plurality of connectors for connecting to the USB device;
wherein a first part of the plurality of connectors is used for transmitting signals between the host device and the USB device in a USB mode;
wherein a second part of the plurality of connectors is retained in a specified state for providing a control signal to control the USB device to enter an operating mode.

2. The fixture of claim 1, wherein an amount of the plurality of first signal pins or an amount of the plurality of second signal pins equals an amount of the plurality of connectors.

3. The fixture of claim 1, wherein the USB mode is a USB2.0 mode or a USB3.0 mode.

4. The fixture of claim 1, wherein the operating mode is a normal mode, in which the fixture bypasses signals between the host device and the USB device, when the specified state is a first pre-defined state.

5. The fixture of claim 1, wherein the operating mode is a return materials authorization (RMA) mode, in which the fixture controls the USB device to start debugging operations, when the specified state is a second pre-defined state.

6. The fixture of claim 1, wherein the operating mode is a low level format (LLF) mode, in which the fixture is capable of controlling the USB device to perform formatting operations, when the specified state is a third pre-defined state.

7. The fixture of claim 1, wherein the specified state is fixed or switchable between a plurality of pre-defined states.

8. A universal serial bus (USB) device, comprising:
a USB connector, for connecting to a host device;
a controller, connected with the USB connector, for controlling operations of the USB device according to a control signal;
a storage unit, connected with the controller, for storing data; and
a fixture, connected with the USB connector, for providing the control signal.

9. The USB device of claim 8, where the fixture comprises:
a plurality of connectors;
a plurality of first signal pins, located at first ends of the plurality of connectors for connecting to the host device; and
a plurality of second signal pins, located at second ends of the plurality of connectors for connecting to the USB connector;
wherein a first part of the plurality of connectors is used for transmitting signals between the host device and the USB device in a USB mode;
wherein a second part of the plurality of connectors is retained in a specified state for providing the control signal to control the USB device to enter an operating mode.

10. The USB device of claim 9, wherein an amount of the plurality of first signal pins or an amount of the plurality of second signal pins equals an amount of the plurality of connectors.

11. The USB device of claim 9, wherein the USB mode is a USB2.0 mode or a USB3.0 mode.

12. The USB device of claim 9, wherein the operating mode is a normal mode, in which the fixture bypasses signals between the host device and the USB device, when the specified state is a first pre-defined state.

13. The USB device of claim 9, wherein the operating mode is a return materials authorization (RMA) mode, in which the fixture controls the USB device to start debugging operations, when the specified state is a second pre-defined state.

14. The USB device of claim 1, wherein the operating mode is a low level format (LLF) mode, in which the fixture is capable of controlling the USB device to perform formatting operations, when the specified state is a third pre-defined state.

15. The USB device of claim 9, wherein the specified state is fixed or switchable between a plurality of pre-defined states.

16. A method for controlling operations of a universal serial bus (USB) device, the method comprising:
a fixture generating a control signal according to a specified state;
the USB device detecting the control signal; and
the USB device entering an operating mode according to the control signal;
wherein the fixture is connected between a host device and the USB device.

17. The method of claim 16, wherein the steps of the fixture generating the control signal according to the specified state comprises the fixture retaining unused pins of the fixture in the specified state to generate the control signal.

18. The method of claim 16, wherein the operating mode is a normal mode, in which the fixture bypasses signals between the host device and the USB device, when the specified state is a first specified state.

19. The method of claim 16, wherein the operating mode is a return materials authorization (RMA) mode, in which the fixture controls the USB device to start debugging operations, when the specified state is a second specified state.

20. The method of claim 16, wherein the operating mode is a low level format (LLF) mode, in which the fixture controls the USB device to perform formatting operations, when the specified state is a third specified state.
